(19) United States
(12) Patent Application Publication
(10) Pub. No.: US 2020/0151848 A1
(43) Pub. Date: May 14, 2020

(54) System and Method for Surface Profiling

(71) Applicant: Hilti Aktiengesellschaft, Schaan (LI)

(72) Inventors: Kent KAHLE, Hayward, CA (US); Vinod KHARE, Westminster, CO (US); Sascha KORL, Buchs (CH); Andreas WINTER, Feldkirch (AT)

(73) Assignee: Hilti Aktiengesellschaft, Schaan (LI)

(21) Appl. No.: 16/625,066

(22) PCT Filed: Jun. 29, 2018
(86) PCT No.: PCT/EP2018/067592

§ 371 Date: Dec. 20, 2019

Related U.S. Application Data
(63) Continuation of application No. 15/639,308, filed on Jun. 30, 2017, now abandoned.

(51) Int. Cl. G06T 3/00; G01B 11/25; G06T 17/20

(52) U.S. Cl. CPC G06T 3/005; G06T 3/0006; G06T 2210/04; G06T 17/20; G01B 11/25

(57) ABSTRACT

A system and method for surface profiling via a projection system, such as a position enabled projector. By way of example, a three-dimensional representation of a physical object, such as an uneven surface of the object, may be generated and profiled. The three-dimensional representation may be a 3D point cloud, a surface mesh, or any other suitable type of representation. A two-dimensional image to be projected onto the surface may undergo an image transformation based on the generated 3D representation of the surface. The transformed image is then projected onto the surface, where the image points projected are at their true positions with true scale. Moreover, the projected image may be automatically updated when the projector is moved to a new position.

### BACKGROUND OF THE INVENTION

Projection mapping, which may also be known as video mapping or spatial augmented reality, is a projection technology used to turn physical objects (often irregularly shaped objects) into a display surface for image and video projection. The objects may be complex industrial landscapes, such as buildings, small indoor objects or theatrical stages. Using software, a two or three-dimensional object is spatially mapped on a virtual program that mimics the real environment that is to be projected on. The software may interact with a projector to fit any desired image onto a surface of that object.

A position enabled projector (PEP) is a tool that projects an image, such as a blueprint, onto a work surface at its true position with true scale. Being able to correctly project position of the image onto a surface may involve determining the position or orientation of the projector itself and/or knowing the surface that the image is being projected onto. If the surface is a smooth, flat, even surface, then the whole image being projected may undergo a single transformation such that every point on the image is projected at the true position. If the surface is uneven, the projector may need to know the exact geometry of the surface and the image being projected may need to undergo a different type of transformation to project the points of the image onto the uneven surface correctly at the true position.

The projection of image points on a surface at their true positions along with true scale is particularly important if a specific task to be performed requires precision and accuracy. For instance, a blueprint may be projected onto a work surface so as to allow a construction worker to drill holes at various specified positions on the surface based on the information provided by the blueprint. If the work surface is uneven, however, the virtual positions of the drill holes may be incorrectly and inaccurately projected when the geometry of the uneven surface is not taken into account. In that regard, there is a need for projecting an image onto an even or uneven surface such that all points of the image are projected and appear at their true position on the surface with true scale. There is also a need for an image being projected to be automatically updated when the projector is moved from its original position to a new position.

### SUMMARY OF THE INVENTION

In accordance with one or more aspects of the present invention, the invention is directed to a system and method for surface profiling via a projector system, such as a position enabled projector. By way of example, a three-dimensional representation of a physical object, such as an uneven surface of the object may be generated and profiled. The three-dimensional representation may be a 3D point cloud, a surface mesh, or any other suitable type of representation. A two-dimensional image to be projected onto the surface may undergo an image transformation based on the generated 3D representation of the surface. The transformed image is then projected onto the surface, where the image points are projected are at their true positions with true scale. Moreover, the projected image may be automatically updated when the projector is moved to a new position.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 illustrates a projector system in accordance with one or more principles of the present invention.

FIG. 2 illustrates a block flow diagram in accordance with one or more principles of the present invention.

FIGS. 3 to 6 illustrate projector systems and respective flow diagrams in accordance with one or more principles of the present invention.

FIG. 7 illustrates a virtual polygon mesh of a three-dimensional structure in accordance with one or more principles of the present invention.

FIG. 8 illustrates a two-dimensional image undergoing image transformation in accordance with one or more principles of the present invention.

FIG. 9 illustrates an image point appearing at a true position with true scale after image transformation in accordance with one or more principles of the present invention.

FIG. 10 illustrates a flow diagram in accordance with one or more principles of the present invention.

### DETAILED DESCRIPTION OF THE DRAWINGS

The present invention is directed to correctly and accurately projecting, using a projector system, a two-dimensional image (e.g., a construction-related blueprint) onto an uneven work surface, such as corrugated steel sheets, so that all points of the image appear on the surface at their true positions with true scale. Moreover, the present invention is directed to updating the projected image when the projector system is moved to a new position.

In one aspect of the present invention, a three-dimensional (3D) profile of the uneven surface may be generated. By way of example, generation of the 3D profile may be implemented by a projector system using the one or more of the following components and/or approaches: (1) a laser scanner, (2) a time-of-flight (TOF) camera, (3) at least one stereoscopy camera based approach, and/or (4) one or more structured light approaches. The 3D profile that is output from the projector system may be a point cloud, a surface mesh, a surface profile, or any other suitable type of three-dimensional representation of the surface. In a further example, the use of one or more range meters may improve the accuracy and robustness of the point cloud.

In another aspect of the present invention, the 3D point cloud of the uneven surface generated by the projector system may be converted to into a virtual surface mesh, such as a polygon mesh. The mesh may be generated based on geometric processing of the surface and virtually reconstructed.

In yet another aspect of the present invention, a two-dimensional (2D) image, such as a blueprint associated with a construction task, may be transformed (e.g., using linear affine transformation) based on the generated polygon mesh of the uneven surface. Optionally, the transformation may also be based on the position and the orientation of the projector system, which is further described in U.S. application Ser. No. 15/638,815, filed on Jun. 30, 2017, the content of which is incorporated herein by reference in its entirety. In at least that regard, the points and/or lines of the blueprint appears at their true positions, despite the uneven characteristics of the projection surface. As such, the construction worker relying on information in the projected blueprint to carry out the construction task may trust that the points, lines, and other graphical representations are where they actually have to be located.

One of the numerous advantages of the present invention is that the true position of every image point on the uneven surface is accounted for, and thus, ensures that tasks such as the afore-mentioned construction task can be performed accurately and correctly. The invention relates to preserving accuracy (e.g., true position, true scale) of the various aspects of a projected image and not merely how the projected image may look to an observer. This may be achieved, for example, by calibrating all system components (e.g., in itself and to each other) based on known-design and/or all data (e.g., point cloud, range, mesh, original and transformed images) may be referenced to a common coordinate system.

The invention described herein may be implemented on and executed by one or more computing devices. For instance, the projector system may have computing capabilities, by way of example, one or more processors, central processing units (CPUs), etc. As will be further described below, the computing associated with surface profiling and projecting a transformed image according to aspect(s) of the present invention may be executed by computing hardware in the projector system itself. Alternatively, the processing may be performed by a separate portable computing device, such as a laptop, tablet computer, or any other suitable type of mobile computing device.

FIG. 1 illustrates an example projector system 110 in accordance with one or more aspects of the present invention. As shown, the projector system 110 includes one or more processors 112, memory 114 (which includes instructions 116 and data 118), and at least one interface 120. The processor 112 may instruct the components of the projector system 110 to perform various tasks based on the processing of information and/or data that may have been previously stored or have been received, such as based on the instructions 116 and/or data 118 stored in memory 114. The processor(s) 112 may be a standard processor, such as a central processing unit (CPU), graphics processor, or may be a dedicated processor, such as an application-specific integrated circuit (ASIC) or a field programmable gate array (FPGA).

The instructions 116 may be one or more sets of computer-executable instructions (e.g., software) that can be implemented by the processor 112. Data 115 may include various types of information (which can be retrieved, manipulated and/or stored by the processor 112), such as information captured from surface profiling equipment to generate a 3D profile, mesh data, one or more images to be projected, one or more transformed images, etc.

Interface 137 may be any component that allows interfacing with an operator or user. For example, interface 137 may be a device, port, or a connection that allows a user to communicate with the projector system 110, including but not limited to a touch-sensitive screen, microphone, camera, and may also include one or more input/output ports, such as a universal serial bus (USB) drive, various card readers, etc. The interface 137 may also include hardware and/or equipment for surface profiling, such as one or more sensors (e.g., image sensors, light sensors), one or more cameras, one or more projectors, one or more range meters, etc.

The projector system 110 may be configured to communicate with other computing devices via network 130. For example, the projector system 110 may communicate with other projector systems, and/or mobile computing devices (e.g., laptops, tablet computers, smartphones). The network 130 may be any type of network, such as LAN, WAN, Wi-Fi, Bluetooth, etc.

Although processing related to at least generating the 3D profile, surface profiling, and/or image transformation are carried out by the one or more processors 112 of the projector system 110, it may be understood that the processing may be performed by external computing devices and/or hardware, such as a mobile computing device, that may be communicating with the projector system 110 via the network 130.

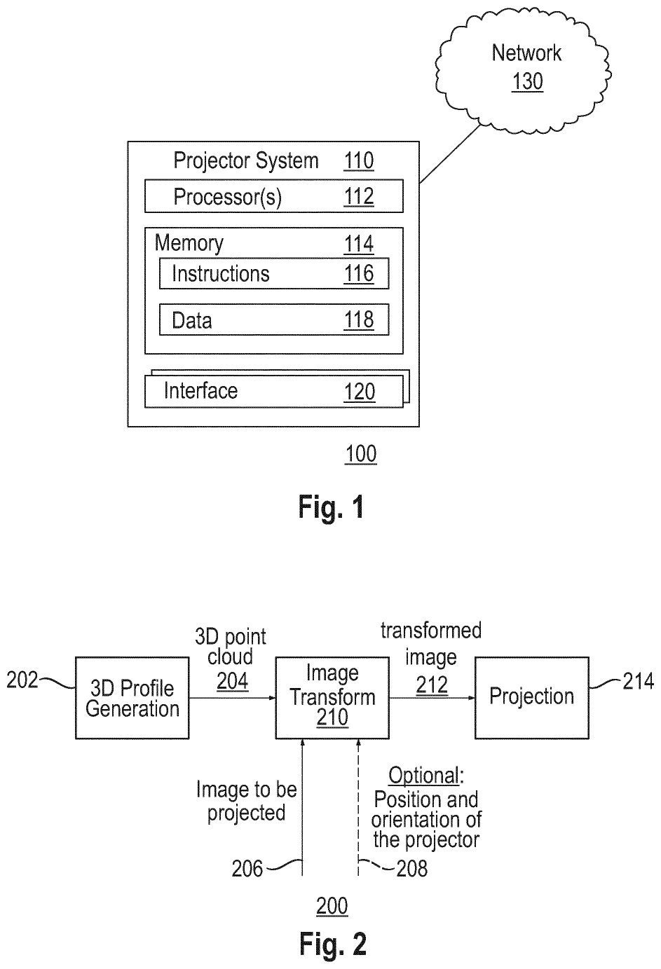

FIG. 2 illustrates a block flow diagram of the above-described processing in accordance with one or more aspects of the present invention. For example, at block 202, the projector system 110 may generate a 3D profile of a particular surface. This may be done by first generating a 3D point cloud 204 of the surface and subsequently generating a 3D polygon mesh based on the 3D point cloud 204, which may be used for image transformation in block 210.

Before image transformation, however, the projector system 110 may take the image 206 to be projected and input it into block 210. Optionally, information on the position and/or the orientation of the projector system 110 may also be input into block 210 for further accuracy. The image 206 may be a two-dimensional image. At block 210, the image 206 to be projected may be mapped onto the polygon mesh and a new two-dimensional image (e.g., a transformed image) is generated for projection at block 214.

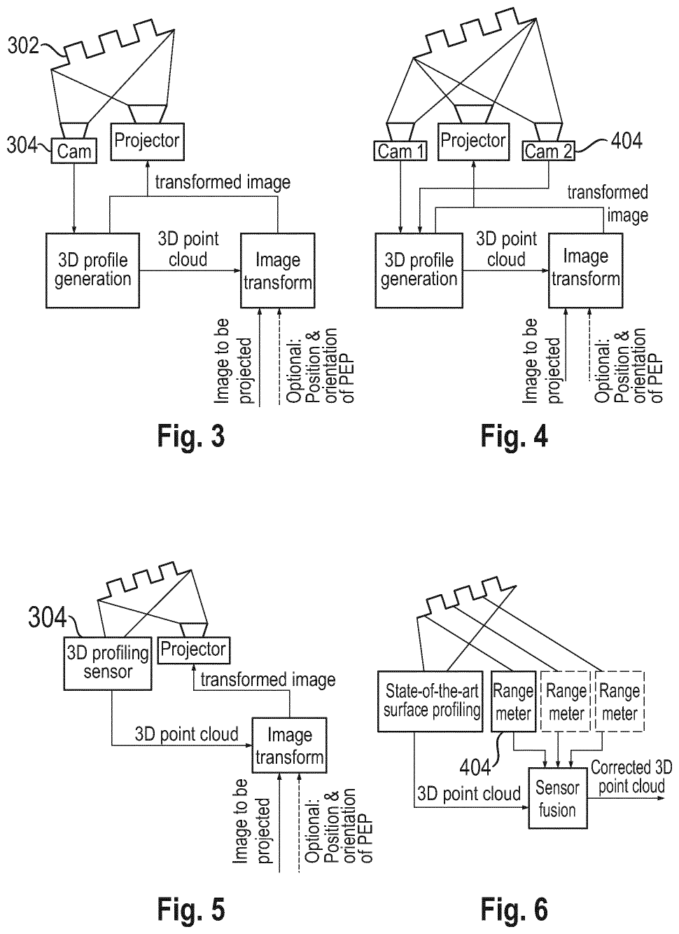

FIGS. 3 to 6 illustrate different embodiments of the projector systems for generating the 3D profile of the surface, transforming and projecting images in accordance with one or more aspects of the present invention. As shown in FIG. 3 (and similarly shown in FIGS. 4 to 6), the projection surface is a corrugated steel sheet 302 (from a top view). The surface of the corrugated steel sheet 302, as illustrated, is uneven due to the numerous bent portions of the sheet 302. In the example of FIG. 3, a single camera 304 may be used to capture images of the surface of the corrugated steel sheet 302. Similar to the processing described above with respect to FIG. 2, based on the captured images via the camera 304, a 3D profile of the surface may be generated and an image to be projected (such as a blueprint for drilling holes on the sheet 302) may undergo transformation and projected using a projector 306. When implementing a single camera configuration, the camera 304 and the projector 306 may need to be mechanically stable and secure relative to each other in order to maintain projection accuracy.

In an example, FIG. 4 shows a projector system that is configured similar to the system of FIG. 3. In FIG. 4, however, an additional camera 404 may be used for generating the 3D profile of the corrugated steel sheet. In this configuration, the two cameras 304 and 404 may also need to be mechanically stable and secured relative to the projector since projectors dissipate heat, which may cause mechanical deformations. The implementations shown in FIGS. 3 and 4 are based on structured light, where a projector projects a series of images onto the surface. An advantage of a structured light approach is that the projector may be used for both projecting the patterns needed for surface profiling and projecting the image of blueprint.

In another example, FIG. 5 shows a projector system using a 3D profiling sensor 504 and configured in a manner similar to the systems of FIGS. 3 and 4. Numerous different technologies for surface profiling may be implemented in the 3D profiling sensor 504 and may be available in the form of commercial, integrated sensors, etc. In some instance, however, state-of-the-art surface profiling techniques and solutions may be sensitive to ambient light, may have limited accuracy (e.g., distance error that is bigger than 1% of the distance between the projector and surface), and may be sensitive to the surface material itself. In that regard and in yet another example in accordance with the present invention, FIG. 6 illustrates a projector system that uses one or more range meters 604 in order to improve the overall accuracy and robustness of the system.

By way of example, FIG. 6 includes at least one range meter 604 (e.g., laser based) for at least one range measurement. Using this measurement, the 3D point cloud that has already been generated may be corrected, for example by way of the shown sensor fusion, such that the distance error is reduced. If, for instance, the generation of the 3D point cloud fails completely (e.g., due to ambient light, bad surface), an approximation of the physical surface may be obtained by three different range measurements (or only one in instances where the surface is known to be perfectly horizontal, such as the floor or ceiling, or two range measurements in instances where the surface is known to be perfectly vertical, such as a wall).

According to aspects of the present invention, a 3D point cloud of an object may be generated using different techniques. For example, a technique based on structured light where a projector is used to project one or multiple light patterns onto the surface may be implemented. These light patterns may be captured by one or more cameras, such as the cameras 304 and 404 of FIGS. 3 and 4, respectively. The captured images by the one or more cameras may then be processed to create a 3D point cloud via various techniques used in the field of computer vision. One example can be found in “Simple accurate, and robust projector-camera processing, visualization and transmission,” Moreno, D. & Taubin, G., 3DIMPVT (2012), pp. 464-71, the content of which is incorporated herein by reference in its entirety. Alternatively, any three-dimensional imaging sensors that are configured to produce a point cloud may be used.

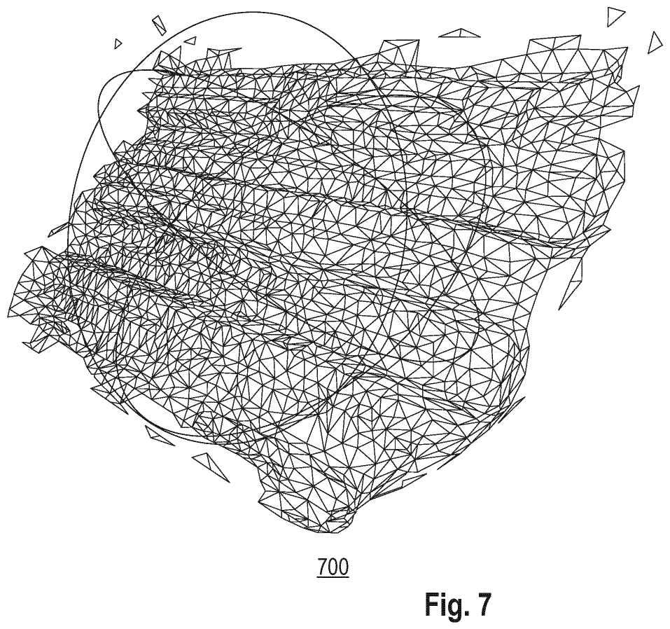

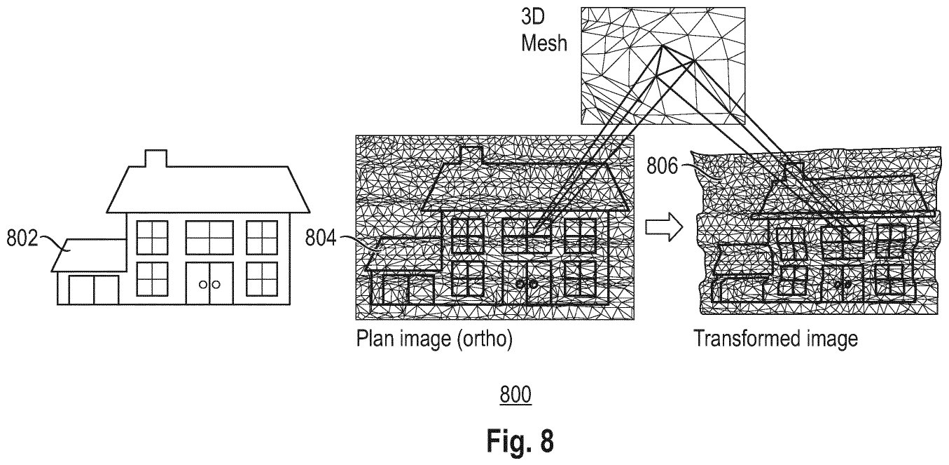

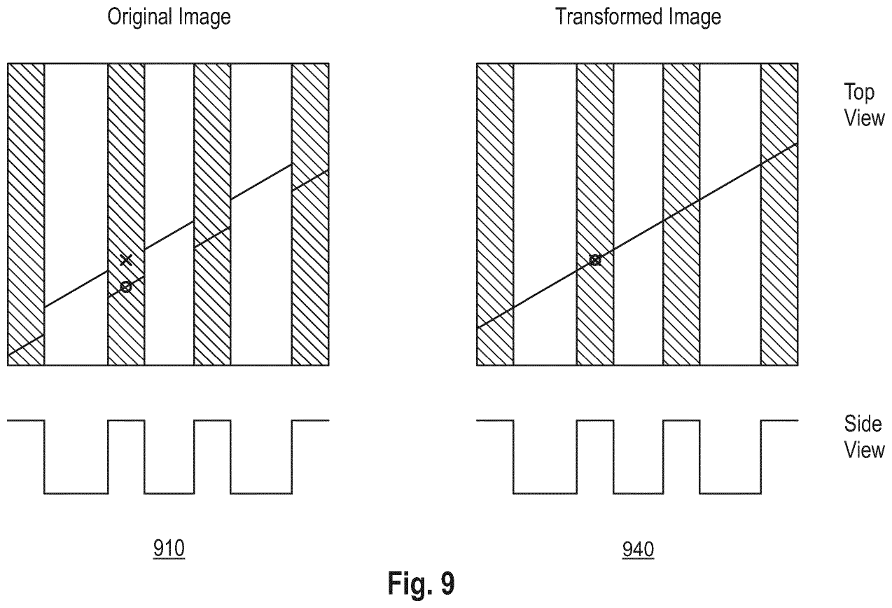

After generating the 3D point cloud, the 3D point cloud may be converted into a polygon mesh, as described above. FIG. 7 illustrates a three-dimensional polygon mesh 700 of the corrugated steel sheet. As shown, the mesh may include and be constructed from numerous polygons, such as triangles, and the three-dimensional polygon mesh may exhibit and/or represent the overall shape of the corrugated steel sheet including the shape of the surface and the numerous bent portions of the sheet. In examples, the conversion from the 3D point cloud to the 3D polygon mesh may be implemented by way of the “Poisson surface reconstruction” method, which is further described in “Poisson Surface Reconstruction,” Kazhdan, M., Bolitho, M., and Hoppe, H., Eurographics Symposium on Geometry Processing (2006), the content of which is incorporated herein by reference in its entirety. In one embodiment, image transformation may be performed using the above-described 3D polygon mesh generated based on the 3D profile. FIG. 8 illustrates this transformation 800 in accordance with one or more aspects of the present invention. The image may be a two-dimensional image, such as a blueprint related to performing a specific task (e.g., blueprint for drilling a hole in the corrugated steel sheet, as will be further described in FIG. 9). As shown in FIG. 8, the two-dimensional image 802 is an image of a house. By way of example, each point in the image 802 may undergo a linear affine transformation based on a 3D polygon mesh, which here is the 3D polygon mesh of the corrugated steel sheet. In addition, the position and/or the orientation may optionally be used in the image transformation.

More specifically, during image transformation, a triangle may be located in a plan image 804 (e.g., ortho) of the image 802 and a corresponding triangle may be located in the 3D polygon mesh, as illustrated in FIG. 8. Thereafter, a suitable affine transformation may be determined for use between the two located triangles. Subsequently, the pixels within the triangle may be filled using the determined transformation. The above steps may then be repeated for all the triangles in the plan image 804. Once the pixels in all, or approximately all, of the triangles are filled in based on the transformation, a transformed image 806 may be produced. It is understood that the transformed image 806 is also a two-dimensional image.

FIG. 8 shows that the transformed image 806 looks as if the image 802 was laid directly on top of the 3D polygon mesh, and in at least that regard, the transformed image 806 virtually takes the shape of the surface on which the image is to be projected on, for example, the corrugated steel sheet. As such, the points and/or lines of the blueprint (e.g., image 802) appear at the true positions on the projection surface (e.g., corrugated steel sheet) so that the points, lines, etc., of the blueprint are actually located where they have to be for the construction worker to accurately perform the specific construction task, such as drilling a drill hole in the steel sheet.

FIG. 9 illustrates image projection onto a corrugated steel sheet with and without proper transformation in accordance with one or more aspects of the present invention. In both image projections 910 and 940, the “x” represents the true position of where a point needs to be located for drilling the drill hole in the steel sheet and the “o” represents the actual location of the projection of the same point.

In image projection 910, for example, if a blueprint image were to be projected onto the corrugated steel sheet without proper image transformation, the point (which indicates where the construction worker needs to drill) would be projected slightly below where the construction worker actually needs to drill. In image projection 940, however, the blueprint image undergoes proper image transformation (such as the image transformation described above) to account for the uneven surface of the corrugated steel sheet, the point that indicates where the construction worker needs to drill is projected at its true position. In other words, as shown in FIG. 9, the “x” and “o” align at the same position.

In embodiments according to aspects of the present invention, when the projector is moved from one position to a new position, the image transformation may be automatically updated based on newly acquired information on the geometric characteristics of the object at the new position. Then, the projector system may automatically update the projection of the updated-transformed image from the new position. In at least that regard, when the construction worker intentionally or accidently moves the projector system, or if the projector system is moved for other reasons, the projected image is constantly and/or automatically updated so that tasks associated with the image being projected may be performed without little to no interruption.

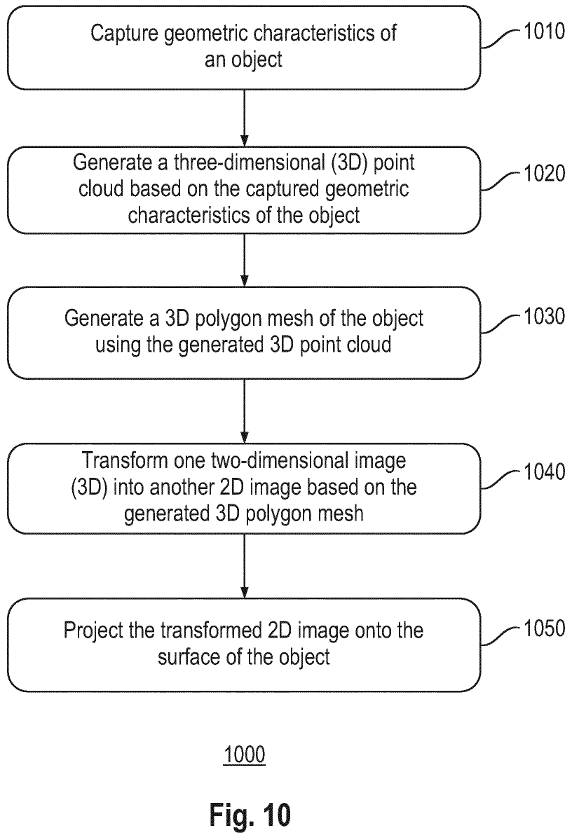

FIG. 10 illustrates a flow diagram 1000 in accordance with one or more aspects of the present invention. It may be understood that the steps of the flow diagram 1000 may be performed or executed by one or more processors of a computing device, whether it may be via the example system 100 of FIG. 1 or via the one or more processors 112 of the projector system 110. Moreover, it may be understood that the order of the steps in FIG. 10 may not be limited thereto, but may be arranged in any suitable order.

In step 1010, the projector system 110, for instance, may capture the overall geometric characteristics of an object, including the surface of the object (whether the surface is even or uneven). As described above, the object may be a corrugated steel sheet and the geometric characteristics may be captured using a laser scanner, a range finding camera (e.g., a time-of-flight camera), stereoscopy (e.g., using two cameras) based approach, structured light approach, etc.

In step 1020, a 3D point cloud of the object may be generated using the obtained overall geometric characteristics in step 1010. Thereafter, in step 1030, the 3D point cloud may be used to generate a 3D polygon mesh of the object, which may be used to transform a 2D image to another 2D image. The 2D image being transformed may be a blueprint for performing a construction-related work task, such as drilling holes.

If the surface is uneven, the generated 3D polygon mesh in step 1030 will transform the 2D image into a new 2D image in step 1040 so that when the new 2D image is projected onto the surface of the object in step 1050, the image characteristics and corresponding information (e.g., as the exact drilling positions) will be projected on the surface at their correct and accurate locations with true scale.

Numerous advantageous of the present invention, include but are not limited to, accounting for the accurate and correct projection of every point, line, characteristic, etc., of an image on an uneven surface, especially if the image that is being projected is related to a task that requires accuracy and precision. In that regard, how the projected image looks to an observer is not the main concern of the present invention, but rather whether one or more points in an image is projected at its true position.

The foregoing invention has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof. Although the present disclosure uses terminology and acronyms that may not be familiar to the layperson, those skilled in the art will be familiar with the terminology and acronyms used herein.

1.-21. (canceled)

22. A system for surface profiling, comprising:
at least one processor for executing stored instructions to:
capture geometric characteristics of an object, the geometric characteristics including a surface of the object,
generate a three-dimensional (3D) point cloud of the object based on the captured geometric characteristics of the object,
generate a 3D polygon mesh of the object based on the generated 3D point cloud,
transform a first two-dimensional (2D) image to a second 2D image based on the generated 3D polygon mesh, and
project the second 2D image onto the surface of the object.

23. The system of claim 22, further comprising one or more of: (i) at least one camera, (ii) at least one laser scanner, (iii) at least one surface profiling sensor, and (iv) at least one projector, wherein the at least one camera, the at least one scanner, the at least one surface profiling sensor, and the at least one projector are configured to profile the surface of the object.

24. The system of claim 23, wherein the at least one camera includes a time-of-flight camera.

25. The system of claim 23, further comprising one or more range meters configured to measure a distance between the one or more range meters and the object.

26. The system of claim 22, wherein the geometric characteristics of the object are captured based on at least one light pattern projected onto the surface and capturing the at least one projected light pattern using one or more cameras.

27. The system of claim 26, wherein the 3D point cloud of the object is generated based on the at least one captured light pattern.

28. The system of claim 22, wherein the 3D polygon mesh is generated based on Poisson surface reconstruction.

29. The system of claim 22, wherein the transformation is based on an affine transformation.

30. The system of claim 22, wherein the 3D polygon mesh includes a plurality of polygons arranged to virtually exhibit an overall shape of the object, wherein the plurality of polygons are triangles.

31. The system of claim 30, wherein the transformation of the first 2D image to the second 2D image further includes the at least one processor executing stored instructions to:
locate a first triangle in an orthoimage of the first 2D image and a second triangle in the 3D polygon mesh corresponding to the first triangle,
determine an affine transformation between the first and second triangles, and
generate a third triangle based on the transformation.

32. The system of claim 22, wherein the surface of the object is an uneven surface.

33. The system of claim 32, wherein the projection of the second 2D image onto the uneven surface of the object is such that all characteristics of the first 2D image are positioned on the uneven surface with true location and true scale.

34. The system of claim 22, wherein the system for surface profiling is included in a position enabled projector.

35. The system of claim 34, wherein the transformation is further based on one or more of: (i) a position of the position enabled projector and (ii) an orientation of the position enabled projector.

36. The system of claim 23, wherein the at least one camera is mechanically secured relative to the at least one projector.

37. The system of claim 22, wherein the first 2D image is a blueprint of a construction-related task.

38. The system of claim 22, further comprising at least two cameras, at least one projector, and at least three range meters, wherein the at least three range meters are configured to measure a distance between each respective range meter and the object.

39. The system of claim 34, wherein the projection of the second 2D image onto the surface of the object is automatically updated, when the position enabled projector is moved based on an updated transformation.

40. A method for surface profiling, comprising the steps of:
capturing, by at least one processor, geometric characteristics of an object, the geometric characteristics including a surface of the object;
generating, by the at least one processor, a three-dimensional (3D) point cloud of the object based on the captured geometric characteristics of the object;
generating, by the at least one processor, a 3D polygon mesh of the object based on the generated 3D point cloud;
transforming, by the at least one processor, a first two-dimensional (2D) image to a second 2D image based on the generated 3D polygon mesh;
projecting, by the at least one processor, the second 2D image onto the surface of the object; and
using the projected second 2D image in a construction task.

41. A non-transitory computer-readable medium comprising a set of executable instructions, the set of executable instructions when executed by at least one processor causes the at least one processor to perform a method for surface profiling, the method comprising the steps of:
capturing geometric characteristics of an object, the geometric characteristics including a surface of the object;
generating a three-dimensional (3D) point cloud of the object based on the captured geometric characteristics of the object;
generating a 3D polygon mesh of the object based on the generated 3D point cloud;
transforming a first two-dimensional (2D) image to a second 2D image based on the generated 3D polygon mesh; and
projecting the second 2D image onto the surface of the object.

42. A computer program product comprising a set of executable instructions, the set of executable instructions when executed by at least one processor causes the at least one processor to perform the method for surface profiling according to claim 40.
